(19) United States
(12) Patent Application Publication
(10) Pub. No.: US 2026/0287318 A1
(43) Pub. Date: Sep. 24, 2026

(54) MEASURING SYSTEM FOR DETERMINING SHAPE, DEFORMATIONS AND/OR CHANGES IN ORIENTATION OF A MEASUREMENT OBJECT

(71) Applicants: HELMUT-SCHMIDT-UNIVERSITAT/ UNIVERSITAT DER BUNDESWEHR HAMBURG, Hamburg (DE); AIRBUS OPERATIONS GMBH, Hamburg (DE)

(72) Inventors: Gerd Scholl, Hamburg (DE); Ralf Heynicke, Ratzeburg (DE); Lars-Michel Bretthauer, Berkenthin (DE); Thomas Hoffmeister, Hamburg (DE)

(21) Appl. No.: 19/475,670

(22) PCT Filed: Apr. 19, 2023
(86) PCT No.: PCT/EP2023/060156

§ 371 Date: Oct. 15, 2025

(51) Int. Cl. G01B 5/20

(52) U.S. Cl. CPC G01B 5/20

(57) ABSTRACT

A measuring system for determining shape, deformations and/or change in orientation of a measurement object (12), the measuring system comprising a plurality of sensor probes (1) attachable as a sensor probe network on a measurement object surface (11). The sensor probes (1) are each directly coupled to a neighboring sensor probe (1) by a mechanical link (19). Sensor devices detect the orientation of a surface normal (13) of the surface (11) at the location of the respective sensor probe (1) relative to a predetermined reference axis and the orientation of each of the mechanical links (19) coupled to the respective sensor probe (1) relative to said surface normal (13) at the location of the respective sensor probe (1) or said predetermined reference axis. An analysis unit determines position and orientation of each of the sensor probes (1) from the measurement signals of the sensor devices.

The present application claims priority to PCT International Application No. PCT/EP2023/060156, filed on Apr. 19, 2023, entitled “MEASURING SYSTEM FOR DETERMINING SHAPE, DEFORMATIONS AND/OR CHANGES IN ORIENTATION OF A MEASUREMENT OBJECT”, which is incorporated herein by reference.

### TECHNICAL FIELD

The invention relates to a measuring system for determining shape, deformations and/or change in orientation of a measurement object, the measuring system comprising a plurality of sensor probes, which can be attached in a distributed manner on a surface of the measurement object in a predefined orientation relative to a surface normal of the surface of the measurement object at the location of the respective sensor probe, so that a deformation and/or change in orientation of the measurement object causes a change of the position and/or orientation of one or more of the sensor probes, wherein each of the sensor probes comprises a fastening device for releasably attaching the sensor probe to the surface of the measurement object.

### BACKGROUND OF THE INVENTION

In industrial manufacturing processes, e.g. in the automotive and aircraft industries, complex joining and position correction processes are sometimes necessary in the final assembly of individual components, such as prefabricated subassemblies. The complexity of the joining processes has various causes, e.g., the general size, complicated shapes or materials of the subassemblies, or the overall precision requirements of the manufacturing process. In some cases, the joining processes are monitored with complex measurement technology, often laser measurement technology. However, their use restricts the accessibility of the production site for personnel. Further, the reliability of the measuring techniques used usually depends on various environmental parameters such that measurement conditions can only be kept constant over time with high effort.

To compensate for measured changes in orientation or form due to mechanical stress and forces acting on subassemblies of the manufacturing process, actuators supporting a subassembly are used for correction of deformations of the subassembly. The use of actuators in the joining processes to correct the shape of subassemblies is tied to high precision in terms of amplitude, effective direction and positioning on the surface of the subassembly. Since many actuators are required for correction, additional temporary contact points are necessary in addition to stationary, reference contact points on the subassembly. In order to be able to use the actuators with the required precision, their setup and use is time consuming. Since the corrections are regularly carried out manually today, their efficiency depends on the individual qualifications of the operating personnel. If the required precision cannot be achieved by the correction processes, time-consuming manual correction processes are also necessary, which also increases the process duration.

In order to shorten process durations and increase their reliability, automated correction units can be used which are based on controlled actuators. This technique can implement closed-loop control systems, which use the measurement signals from the measurement technology to control the actuators. The use of actuators for shape correction should be automated in such a way that their actual amplitude, effective working direction relative to the surface of the subassembly and the contact points with the surface of the subassembly are known at all times to enable permanent alignment between the set and the actual orientation and shape of the components. However, this requires reliable measurement technology that is capable of efficiently measuring the position of components, such as the subassemblies mentioned above, and in particular reliably detecting changes in orientation and shape.

From EP 3 159 653 B1 a measuring system according to the preamble of claim 1 is known which has for the purpose of detecting distortion, bending or torsion of an object a number of sensor probes distributed on the surface of a measuring object. Between the sensor probes a distance x and/or an angular position a are defined. By detecting changes of the distance and/or the angular position between the probes distortion, bending or torsion can be detected. The sensor probes have sensor devices, based for example on ultrasonic sensor technology, which measure a distance and/or a relative angular position between the sensor probes. However, due to the measurement technology used, it is not readily possible to simultaneously measure mechanical stretching and bending of the measurement object. This considerably restricts the use for e.g. the complex joining processes described above, because changes in shape or even orientation of the measurement object such as subassembly are not detected precisely enough.

U.S. Pat. No. 9,777,568 B2 and US 2016/0 108 719 A1 describe measuring systems that determine the shape of an object by means of articulated rods. The rods are arranged in a chain, i.e., in series, and are placed loosely on the object to be measured. The measuring system has sensors to determine the orientation of the rods and derive the shape of the measurement object therefrom. Due to the chain-like arrangement of the rods, the rods only ever represent the shape of the measurement object along one axis.

It is an object of the invention to provide a measuring system and method capable of detecting the shape, deformations and/or changes in orientation of a measurement object, such as a component or a subassembly in a more efficient manner so that corrective measures, such as by means of actuators, can be implemented in a more precise manner.

### SUMMARY OF THE INVENTION

The object of the invention is achieved by a measuring system as defined in claim 1 and by a measuring method as defined in claim 14. Further and preferred embodiments of the invention are disclosed in the following description and in the dependent claims.

According to the invention, each of the distributed sensor probes is directly coupled to one or more neighboring sensor probes, wherein a plurality of the sensor probes is directly coupled to at least two neighboring sensor probes, thereby forming a two-dimensional sensor probe network, wherein for the direct coupling of two sensor probes a mechanical link is used such that the sensor probes and the mechanical links form the sensor probe network, wherein the sensor probes define nodes of the sensor probe network. Sensor devices are assigned to each of the sensor probes to detect the orientation of the surface normal of the measurement object surface at the location of the respective sensor probe relative to a predetermined reference axis and to detect the orientation of each of the one or more of the mechanical links coupled to the respective sensor probe relative to said surface normal or said reference axis at the location of the respective sensor probe. The measuring system further comprises an analysis unit which is configured to receive and evaluate measurement signals from the sensor devices, the analysis unit being configured to determine the position and orientation of each of the sensor probes from the received measurement signals.

As reference axis for the orientation of the surface normal, the direction of the earth gravity field can be used. It is also possible to use another predetermined reference axis. With the orientations of the surface normals at the location of each of the sensor probes and in particular the spatial orientation of the mechanical links, the shape, a deformation, but also a change in the orientation of the measurement object can be determined by the analysis unit by determining the positions and orientations of the sensor probes. For this purpose, the analysis unit can perform calculations including information about the distances between the sensor probes or the lengths of the mechanical links, which can be predefined or additionally measured.

Preferably, the positions and orientations of the sensor probes and, in particular, changes thereof is transferred to or mapped in a coordinate system of the measurement object, thereby reflecting the position and orientation of the corresponding surface sections to which the sensor probes are attached. This means that for the measurement object the positions and orientations of the sensor probes provide a very accurate information of its shape, orientation and any changes thereof.

The sensor probe network is scalable and cascadable, which means that the distances between the sensor probes can be freely selected and the sensor probe network can be expanded as required to cover a wide range of measurement objects and shapes. Scalable also means that the network or a standard cell thereof can also be miniaturized, e.g. realized in silicon, and also be employed for very large structures in size. The sensor probe network does not necessarily have to contain a uniform distribution of the sensor probes, e.g., it is possible to use a narrower arrangement of the sensor probes in areas with a high geometrical geometric change or in an area where there is a greater metrological interest.

A unit for electronic data processing, such as a personal computer, a works station or a microprocessor are particularly suitable as analysis unit. The sensor probes preferably have a device for wireless transmission of the measurement signals, e.g. by electromagnetic waves, to the analysis unit. This enables the sensor probe network to operate wirelessly.

The sensor probe network is a two-dimensional network. This term essentially refers to the structure when the sensor probe network is spread over an area and one can see from above a set of nodes (sensor probes) connected by network struts (mechanical links). The sensor probe network can also be placed on curved or angular surfaces. As it can be attached like a two-dimensional mesh on a surface, the term two-dimensional network is used. The term “strut” as used herein in particular refers to a direct mechanical connection between two sensor probes, wherein the strut can be rigid to prevent movement of the connected sensor probes towards and away from each other or wherein the strut can allow movement of the connected sensor probes towards and away from each other, for example the strut can be a telescopic rod.

The fastening device comprises a space in which a vacuum is formed after bringing the opening of the space of the probe into contact with the surface of the measurement object, e.g. by use of a suction bell at the lower end of the sensor probe. Further, the sensor probes may comprise an evacuable space such as a vacuum chamber, which is applied to the surface of the measurement object and which is connectable to a vacuum source. For this purpose, each of the sensor probes may have a connection for coupling the vacuum chamber to a vacuum source. Alternatively or additionally, the attachment of the sensor probes to the surface of the measurement object may based on electromagnetism, magnetism, adhesion, screw connection or other detachable connections.

The fastening device is designed so that the sensor probe takes a predefined orientation relative to the surface normal at the location of the respective sensor probe. For this purpose, a base of the sensor probe can have a correspondingly shaped bottom, e.g., a flat bottom surface that is perpendicular to a vertical axis of the sensor probe. Preferably, the fastening device is configured such that a vertical axis of the sensor probe coincides with the surface normal of the measurement object surface at the location of the respective sensor probe. The vertical axis of the sensor probe preferably extends through a pivotal connection of the mechanical link connected to the respective sensor probe.

According to a further embodiment of the invention, for each of the sensor probes, the pivotal connection of the mechanical link to the respective sensor probe is located at a predetermined height above the surface on which the respective sensor probe is attached.

According to a further embodiment of the invention, the analysis unit is configured to determine the relative position and/or orientation of each of the sensor probes to directly coupled neighboring sensor probes.

According to a further embodiment of the invention, the sensor devices comprise sensors to detect the angle between each of the mechanical links coupled to the respective sensor probe and a plane that extends perpendicular to the surface normal of the surface of the measurement object at the location of the respective sensor probe. Thereby, the orientation of the mechanical link, which corresponds to the direction of a longitudinal axis of the mechanical link in space, is effectively determined. The plane that extends perpendicular to the surface normal is in a fixed orientation (namely parallel to) with respect to the surface of the measurement surface at the location of the respective sensor probe and therefore also reflects the orientation of the mechanical link relative to the surface at the location of the respective sensor probe. The angle does not have to be measured directly. It can also be derived from the angle between the longitudinal axis of the mechanical link and the vertical axis of the sensor probe.

According to a yet further embodiment of the invention, each sensor device comprise a sensor for detecting the orientation, e.g. the inclination, of the sensor probe relative to the earth's gravitational field. For this purpose, triaxial acceleration sensors may be used. By using the earth's gravitational field the orientation of the surface normal of the measurement object surface at the location of the respective sensor probe relative to the predetermined reference axis defined by the earth's gravitational field can be determined in an efficient manner.

According to a still further embodiment, sensors for detecting the orientations of at least some of the mechanical links relative to the earth's gravitational field are provided. Said sensors may include inclination sensors, preferably triaxial acceleration sensors, which are connected to the mechanical links, e.g., by mounting the sensors on the mechanical link or a bearing support for the mechanical link in the respective sensor probe, the bearing support moving in correspondence with the mechanical link.

According to a further embodiment of the invention, one or more of the sensor probes are defined as reference sensor probes with known positioning in the coordinate system of the measurement object, and the analysis unit is configured to determine the position and orientation of each of the other sensor probes relative to the one or more of the reference sensor probes. By designating reference sensor probes, a fixed geometrically referenced connection to the measurement object structure is provided. This means that a reference is always ensured between the position of the reference sensor probes and the coordinates on the surface of the measurement object. Accordingly, according to a further embodiment of the invention, the analysis unit is configured to assign fixed coordinates in a coordinate system of the measurement object to the reference sensor probes.

According to a further embodiment of the invention, the mechanical links are variable in length, and distance detection devices are provided for detecting the distance and/or a change thereof between directly coupled sensor probes. For example, the distance detection devices may detect a length or a change of the length of the mechanical links, such as struts with variable length, by interferometrical, capacitive, inductive or by other, non-contact distance measurement methods. The length/distance measurement can be absolute or relative. With a relative measurement, an initial distance or length value between should be determined. For example, two strut parts may be arranged to move relative to each other in a telescopic manner. A linear roller or sliding bearing may provide a low-friction connection between the two struts parts. Telescopic rod elements are also a possible implementation of a mechanical link that is variable in length.

According to a further embodiment of the invention, the mechanical links are rigid struts or rods and the fastening devices of each of the sensor probes allow displacements of the respective sensor probe along the surface of the measurement object within predetermined limits. For example, a flexible suction bell including bellows that allows movement of the sensor probe relative to the suction point may be used for this purpose.

According to a further embodiment of the invention, the sensor probes are directly coupled such that three sensor probes form vertices of a triangle, each of said sensor probes being directly coupled to the other two sensor probes by a mechanical link, respectively, wherein the analysis unit is configured to determine the interior angles of the triangle based on a length of the mechanical links. The sensor probe network may be configured to include one or more of said triangles. In addition, one or more of the sensor probes may be part of one or more triangles. This allows translational movements of the sensor probes in the plane of the sensor probe network to be detected in a particularly precise manner.

According to a further embodiment of the invention, the mechanical links are supported on the sensor probes by spherical bearings.

According to a yet further embodiment of the invention, each of the mechanical links defines a longitudinal axis along which the mechanical link connects two sensor probes and the sensor devices comprise sensors to detect a rotation of each of the mechanical links about its own longitudinal axis. For this purpose, rotation sensors or angle sensors are suitable, which measure the rotation of the mechanical link to a reference plane or axis such as the vertical axis of a sensor probes connected with the respective mechanical link.

According to a further embodiment of the invention, the measuring system comprises transmitters and receivers for electromagnetic, acoustic or optical waves, such as in particular laser beam sources, and receivers for the electromagnetic waves, such as in particular a camera sensor, wherein the transmitters are attached to the mechanical links and the receivers are attached to the sensor probes, or vice versa, for detecting a rotation of each of the mechanical links about its own longitudinal axis and/or to detect an angle between each of the mechanical links, i.e., their longitudinal axes and a reference axis, such as the vertical axis of the respective sensor probe or a plane that extends perpendicular to the surface normal of the measurement object surface at the location of the respective sensor probe.

According to a yet further embodiment of the invention, the sensor probes each include an energy source, such as a battery, for self powered operation.

The invention also relates to a method of determining a shape, deformations and/or change in orientation of a measurement object, the method comprising the steps of:
providing a measuring system as described herein;
distributing and attaching the sensor probes as a network of sensor probes on a surface of the measurement object;
determining the position and orientation of the individual sensor probes by evaluating measurement signals provided by the sensor devices;
determining a shape, deformation and/or change in orientation of the measurement object based on the determined positions and orientations of the individual sensor probes.

According to a further embodiment of the invention, the position and orientation of the individual sensor probes are determined in or transferred to a coordinate system defined for the measurement object.

According to a further embodiment of the invention, wherein one or more of the sensor probes are defined as reference sensor probes such that absolute coordinates of the reference sensor probes are set with respect to a coordinate system of the measurement object, wherein a deformation of the measurement object is determined based on the positions and orientations of the sensor probes relative to one or more of the reference sensor probes.

According to a further embodiment of the invention, the determined positions and orientations of the individual sensor probes are used to control and/or regulate a device for correcting the shape, orientation and/or position of the measurement object by means of actuators.

According to a further embodiment of the invention, the measurement signals from the sensor devices are wirelessly transmitted to a higher evaluation or processing unit.

### BRIEF DESCRIPTION OF THE FIGURES

The invention will now be described referring to exemplary embodiments shown in the Figures, in which:

FIG. 1 shows a sensor probe according to a first embodiment of the invention in a sectional view;

FIG. 2 schematically shows the sensor probe network of the measuring system in a top view according to further embodiment of the invention;

FIG. 3 illustrates two neighboring sensor probes in a sectional view according to a further embodiment of the invention;

FIG. 4 illustrates a mechanical link between two neighboring sensor probes in a sectional view according a further embodiment of the invention;

FIG. 5 shows a partial view of a sensor probe in a sectional view in accordance with a further embodiment of the invention;

FIG. 6 shows an exemplary embodiment of a measurement system for measuring a length change of a measurement object;

FIG. 7 shows an exemplary embodiment of a measurement system for measuring bending of a measurement object;

FIG. 8 shows an illustration of geometric relationships between a pair of sensor probes;

FIG. 9 shows another exemplary embodiment of a measurement system for measuring a bending of a measurement object;

FIG. 10 shows a triangular arrangement of sensor probes in a measuring system according to a further embodiment of the invention;

FIG. 11 shows an arrangement of sensor probes of a measuring system in accordance with a further embodiment of the invention; and

FIG. 12 shows in a perspective view, the arrangement of sensor probes on a measurement object in a perspective view.

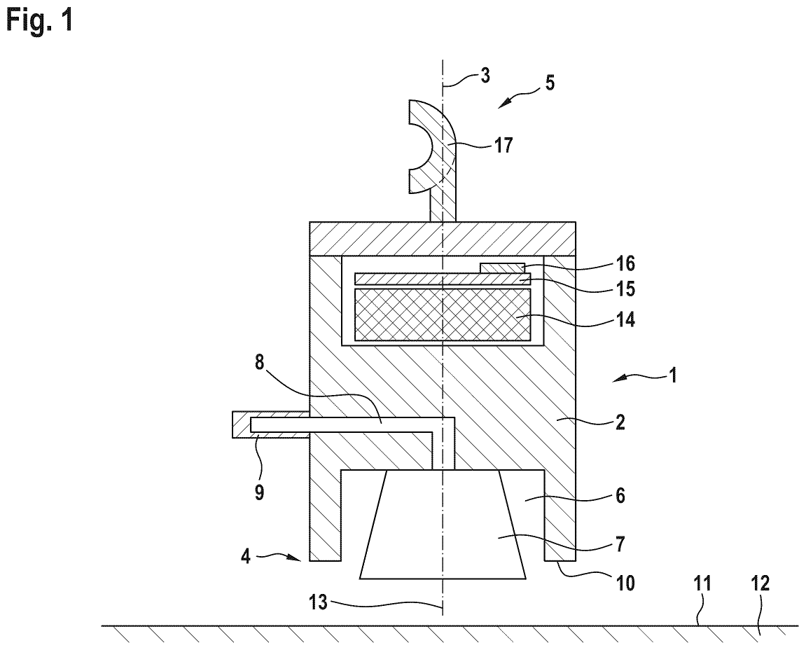

FIG. 1 illustrates a sensor probe 1 with a probe body 2 extending along a vertical axis 3 of the probe body 2 from a lower end 4 to an upper end 5. At the lower end 4 of the probe body 2 a downwardly open space 6 is formed, in which a suction bell 7 is arranged. The suction bell 7 is open at its lower, wider end. The upper end of the suction bell 7 communicates with a channel 8 formed in the sensor body 2, which has a port 9 for a vacuum source. A circular mounting surface 10 is formed at the lower end 4 of the sensor body 2, which is located in the direction of the vertical axis 3.

The suction bell 7 serves as a fastening device for firmly but releasably attaching the sensor probe 1 to the surface 11 of a measuring object 12, such as a component or a subassembly. For this purpose, the lower end of the suction bell is placed on the surface 11 of the measurement object 12 and a vacuum is built up in the suction bell 7 by a vacuum source connected to the port 9, whereby the sensor probe 1 is sucked onto the surface 11 of the measurement object 12. When the sensor probe 1 is sucked on the surface 11, the mounting surface 10 rests on the surface 11 of the measurement object 12 in such a way that the vertical axis 3 runs perpendicular to the surface 11 at the location of the sensor probe 1. Thereby, the vertical axis 3 coincides with a surface normal 13 of the surface 11 of the measurement object 12 at the location of the sensor probe 1, i.e., the fastening device is adapted such that the sensor probe 1 can be attached on the surface 11 of the measurement object 12 in a predefined orientation relative to the surface normal 13 at the location of the respective sensor probe.

It is noted that FIG. 1 shows the sensor probe 1 above the surface 11 of the measurement object 12 before it is lowered on and attached to the surface 11 of the measurement object 12.

The port 9 is provided as a quick coupling. This allows the vacuum source to be disconnected from the sensor probe 1 and the vacuum in the suction bell 7 to be maintained. This also allows self-sufficient operation without a vacuum pump. The sensor probe 1 can also be provided with a self-monitoring device of the vacuum in order to regulate the negative pressure required to firmly attach the sensor probe 1 to the surface 11.

Inside the sensor probe body 2, an energy source 14 in the form of a battery is arranged, which enables self-sufficient operation of the sensor probe 1. In addition, an evaluation circuit 15 with microcontroller and a sensor device in the form of a triaxial acceleration sensor 16 are also installed. The triaxial acceleration sensor 16 detects the orientation, i.e., the inclination, of the vertical axis 3 of the sensor probe 1 relative to a reference axis, here defined by the earth's gravitational field.

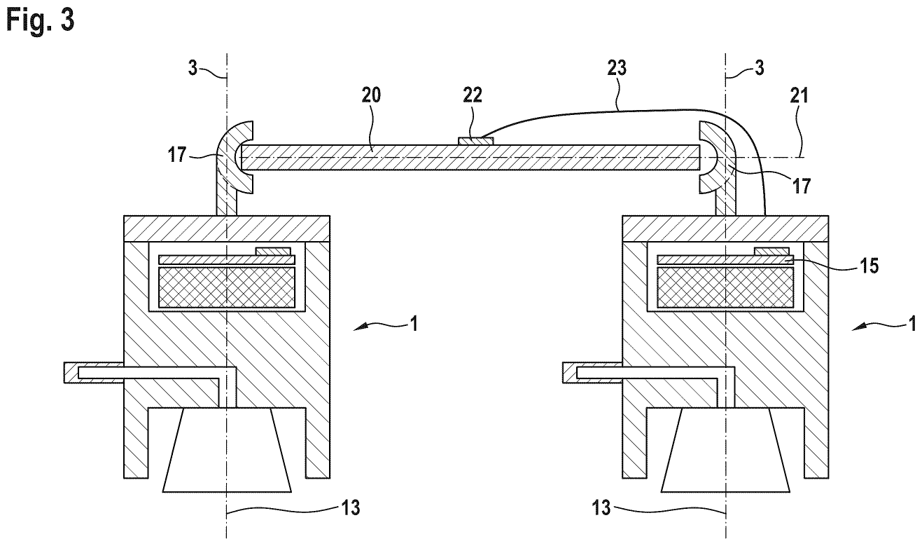

At the upper end 5 of the sensor probe 1 a spherical bearing 17 is schematically shown for connecting the sensor probe 1 to a mechanical link in the form of a strut (now shown in FIG. 1, see FIG. 3). The sensor probe 1 has several corresponding bearings, so that a plurality of struts can be connected to the sensor probe 1. The bearing 17 is configured to allow pivotal movement of the mechanical link around the vertical axis 3 and an axis that runs perpendicular to the vertical axis 3.

Due to the design of the fastening device and predefined dimensions of the sensor probe body, the components of the sensor probe, in particular the spherical bearing 17 and the triaxial acceleration sensor are located at a predetermined height relative to the surface 11 of the measurement object 12.

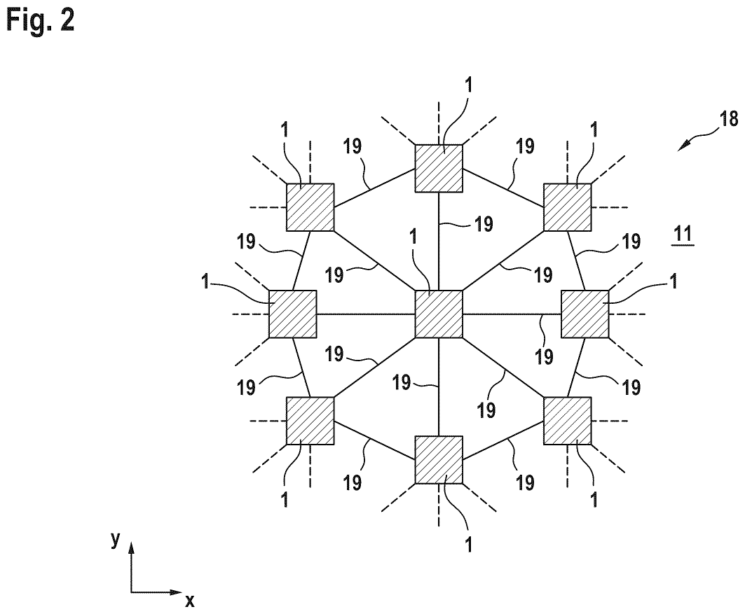

FIG. 2 shows schematically the topology of a sensor probe network 18 on a surface 11 of a measurement object in a top view on a X-Y coordinate system. On the surface 11 of a measurement object a plurality of sensor probes 1 is attached in a distributed manner. Each of the sensor probes is attached in a predefined orientation relative to the surface normal at the location of the respective sensor probe 1 (e.g., the vertical axis of the sensor probe coincides with the surface normal, as described above in connecting with FIG. 1).

Each of the distributed sensor probes 1 is directly coupled to a plurality of neighboring sensor probes by mechanical links 19 in the form of struts, with exactly one strut provided for the direct connection between two probes. The struts and the sensor probes 1 form the two-dimensional sensor probe network 18, wherein the sensor probes 1 define nodes of the sensor probe network 18.

Dotted lines indicate further possible connections for mechanical links so that the sensor probe network 18 can be extended to more sensor probes.

FIG. 3 shows the connection of two neighboring sensor probes 1,1 by a mechanical link. The sensor probes are attached to a surface of a measurement object (not shown). The vertical axis 3 of each of the sensor probes 1 coincides with a surface normal 13 at the location of the respective sensor probe. The mechanical link is a rigid strut 20 with a fixed length. The strut 20 has a longitudinal axis 21 running between both ends of the strut 20. At each end of the strut 20, the strut 20 is connected to the spherical bearings 17 of the sensor probes 1. The spherical bearings 17 allow rotation of the bearing point of the respective end of the strut 20 around the vertical axis 3 of the respective sensor probe 1 and an axis perpendicular thereto. Sensor devices are assigned to each of the sensor probes to detect orientation of the strut 20 relative to a surface normal at the location of the respective sensor probe or another reference axis at the location of each of the sensor probes. Said sensor devices include an inclination sensor 22, e.g., a triaxial acceleration sensor connected with the strut 20 to detect a tilt of the strut 20 relative to the earth's gravitational field. Thereby, the angle between the strut 20 and a plane that runs perpendicular to the surface normal of the surface of the measurement object at the location of the respective sensor probe or another reference axis can be derived. The tilt sensor 22 is connected to the evaluation circuit 15 of one of the sensor probes 1 by wire 23 for signal transmission. Alternative the tilt sensor 22 can be connected wirelessly to an analysis unit.

The fastening devices of the sensor probes 1 are adapted to allow displacements of the respective sensor probe 1 along the surface of the measurement object within predetermined limits. In the embodiment shown, the suction bell is flexible and includes bellows that allow movement of the sensor probe relative to the surface of the measurement object.

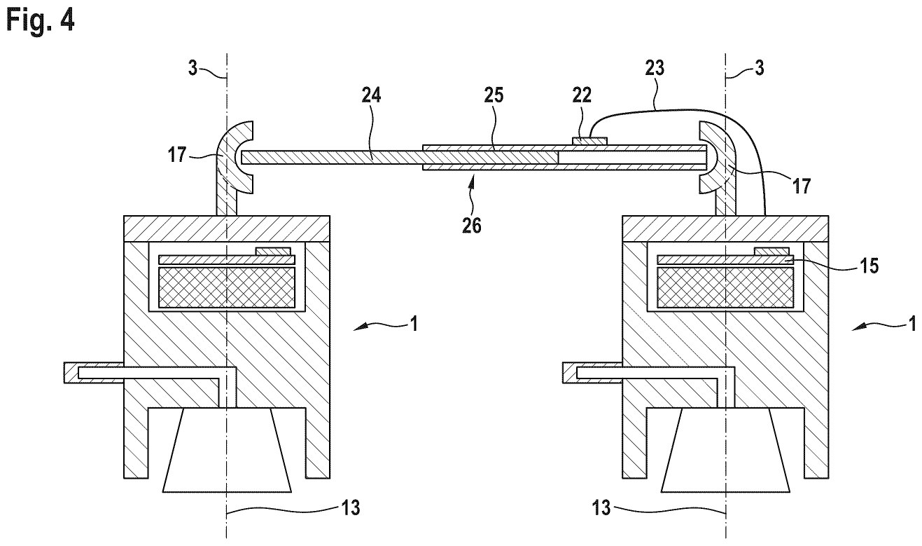

FIG. 4 shows the connection between two neighboring sensor probes 1, 1 by a mechanical link in the form of a strut 24 in the form of a telescopic rods arrangement with variable length. The sensor probes are attached to a surface of a measurement object (not shown). The vertical axis 3 of each of the sensor probes 1 coincides with a surface normal 13 at the location of the respective sensor probe. The strut 24 comprises two parts, the part being connected to one of the bearings 17 of the sensor probes 1, respectively, and interconnected by a linear displacement unit 25, e.g. a linear roller bearing.

In contrast to the embodiment in FIG. 3, the fastening mechanism of the sensor probes 1, 1 is such that the sensor probes 1, 1 cannot move along the surface of the measurement object but are fixed in place.

Sensor devices are assigned to each of the sensor probes to detect orientation of the strut 24 relative to the surface normal 13 or another reference axis at the location of each of the sensor probes. This includes, as shown in FIG. 3, an inclination sensor 22 connected to the strut 24.

Further, the sensor devices comprise a distance detection device 26 for detecting the distance between directly coupled sensor probes. This device detects the length or the change of the length of the strut 24. The length can be determined interferometrically, capacitively, inductively or via other, non-contact distance measurement methods. The length measurement can be absolute or relative. With a relative measurement, an initial distance between the sensor probes must determined. The tilt sensor 22 and the distance detection device 26 are connected to the evaluation circuit 15 of one of the sensor probes 1 by wire 23 for signal transmission. Alternative the tilt sensor 22 and the distance detection device 26 can be connected wirelessly to an analysis unit.

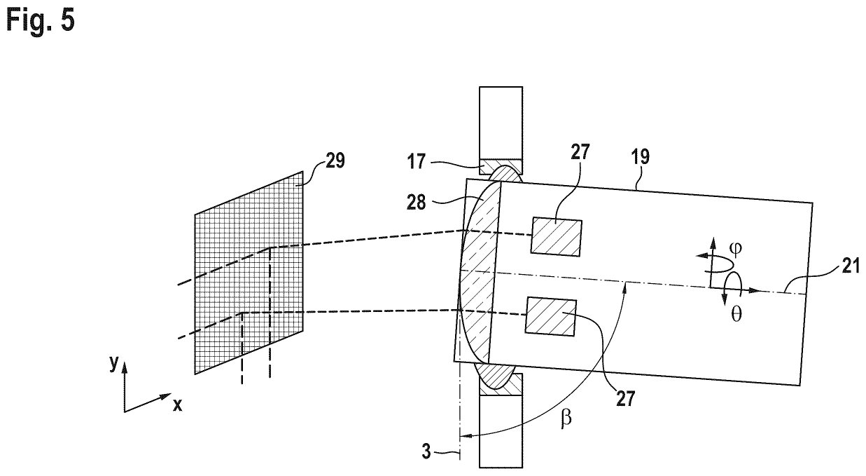

FIG. 5 shows schematically part of a sensor probe in accordance with a further embodiment of the invention. One end of a mechanical link 19 in the form of a strut is supported by a spherical bearing 17 at the upper end of a sensor probe. Indicated are further the vertical axis 3 of the sensor probe and the longitudinal axis 21 of the mechanical link 19. Sensor devices are provided for detecting a rotation of the mechanical link 19 about its own longitudinal axis 21. These sensor devices are also for determining the angle between the mechanical link and a plane that extends perpendicular to the surface normal of the surface of the measurement object at the location of the respective sensor probe. The sensor devices include transmitters 27 in the form of laser beam sources which are mounted in the mechanical link 19. A lens 28 is located in front of the transmitters 27 to focus the laser beams and to direct the laser beams to a receiver 29 in the form of a camera sensor, which is firmly mounted on the sensor probe.

Indicated are further an angle β between the longitudinal axis 21 of the mechanical link 19 and the vertical axis 3 of the sensor probe, an angle θ, which indicates the rotation of the mechanical link 19 about its own longitudinal axis 21, and an angle φ which corresponds to the rotation of the mechanical link 19 around the vertical axis 3 of the sensor probe.

Upon movement of the mechanical link 19, the laser beams move at an angle change of Δβ, Δφ or Δθ on the surface of the camera sensor, which detects the position of the laser beams in an X-Y coordinate system. The positions can then be converted to angles β, φ, and θ. Thereby the orientation and rotation of the mechanical link 19 relative to the vertical axis 3 or other reference axes, such as the surface normal of the surface of the measurement object at the respective location of the sensor probe can be determined. Only one laser beam source is required to measure the angles β, φ. The measurement can be made at both ends of the strut 19.

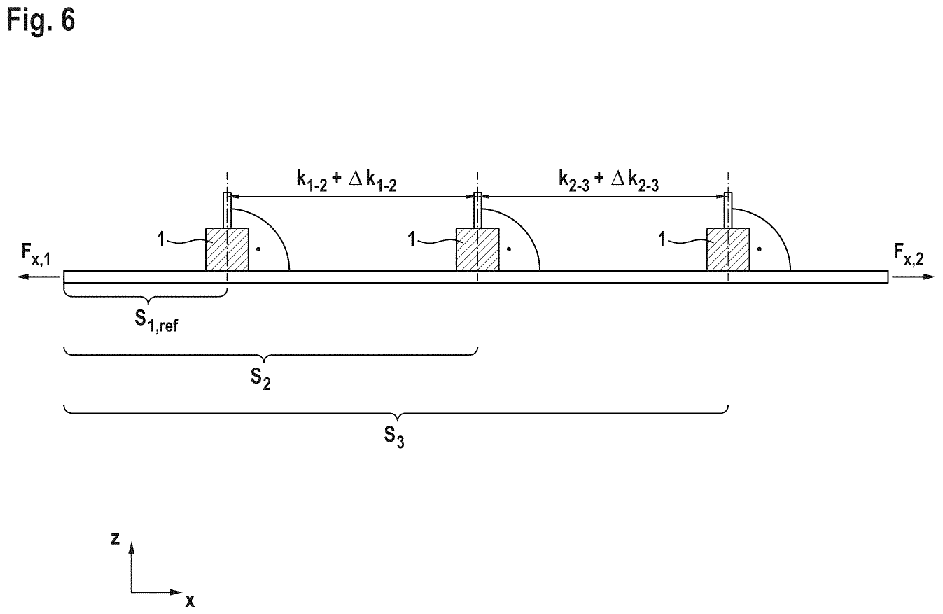

FIG. 6 shows the setup of a measuring system for a measurement of a pure change in length as a result of tension/compression of a measurement object. In this case, a reduced setup is shown with three sensor probes 1 which are attached in series along the surface of a measurement object 12. The struts connecting neighboring sensor probes are not shown. The illustration is comparable to a side view of the sensor probe network shown in FIG. 2 and is therefore illustrated in an X-Z coordinate system of the measurement object.

The left end of the measurement object 12 is defined as a reference point, since the distances and positions of sensor probes relative to the reference can be used to determine the change in length of the measurement object. The sensor probes are orthogonal to the surface 11 of the measurement object 12 at all times.

The measuring system setup is able to measure a change of the distances between neighboring sensor probes by means of distance detection device as explained above. The initial distances between the sensor probes are known, but they can also be determined by the distance detection devices, if these are set up for this. The sensor probes each communicate with an analysis unit (not shown), such as an electronic data processing unit, by wireless data transmission. The analysis unit receives and evaluates the measurement signals from the sensor devices to determine changes in length of the measurement object as a result of tensile and compressive forces.

As shown in FIG. 6, the counter-acting forces F_{x,1} and F_{x,2} pull on the measurement object 1-dimensionally in opposite directions. The changes of the distances between neighboring sensor probes are determined by distance detection devices mounted in the respective mechanical links. For example the position of the third sensor probe shown in FIG. 3 can be determined in the coordinate system of the measurement object by:

$${S}_{3} = ( {k}_{2 - 3} + Δ {k}_{2 - 3} ) + ( {k}_{1 - 2} + Δ {k}_{1 - 2} ) + {S}_{1 , r e f} = ( {k}_{2 - 3} + Δ {k}_{2 - 3} ) + {S}_{2} \qquad ( 1 )$$

S refers to the absolute position of a sensor probe in the measurement object coordinate system. Indices i and j are used for the numbering of the sensor probes, e.g., the notation 3 as in S₃ describes the absolute position of the third sensor probe. S_{1,ref} is the absolute position of a reference sensor probe, whose absolute position in the measurement object coordinate system is known and from which all sensor probe positions S, here sensor probe positions S₂ and S₃, are derived. The index notation i-j refers to the connection between sensor probes i and j, e.g., the notation k₂₋₃ and Δk₂₋₃ describes length and length change of the connection between the second and the third sensor probe.

Furthermore, the strain between two sensor probes can be determined from

$${ε}_{i - j} = \frac{Δ {k}_{i - j}}{{k}_{i - j}} \qquad ( 2 )$$

From the strain ε and the elastic modulus E of the material of the measurement object the mechanical stress σ in the material can be determined using Hook's law from

$$σ = E \times ε \qquad ( 3 )$$

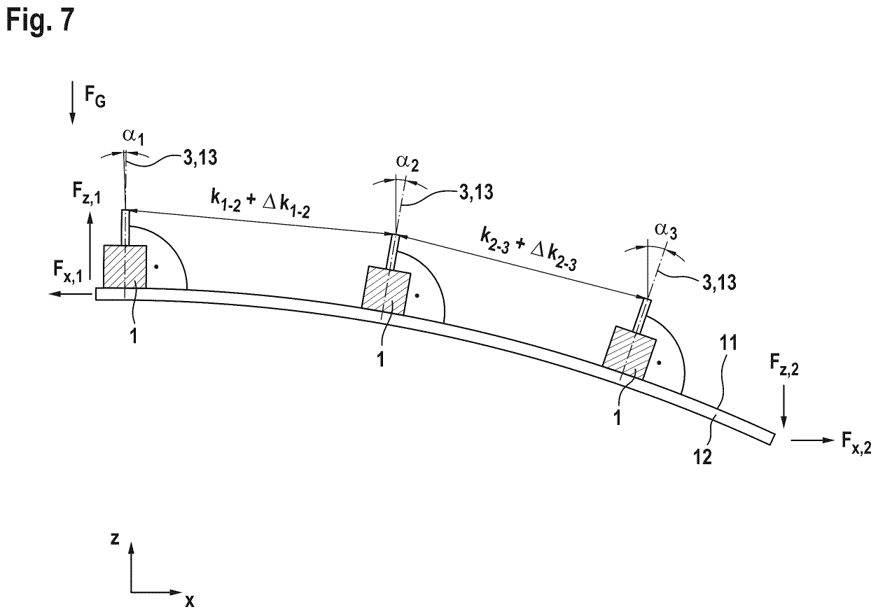

FIG. 7 shows a measurement system setup on a curved surface. As a result of the forces F_{x,1}, F_{z,1}, F_{x,2} and F_{z,2} tensile, compressive and bending loads are generated in the measurement object.

The arrangement of the sensor probes 1 corresponds to the arrangement shown in FIG. 6. The mechanical links connecting neighboring sensor probes are not shown. The changes of the distances between neighboring sensor probes are determined by distance detection devices mounted in the respective mechanical links. In addition, each of the sensor probes detects the orientation or the inclination of the respective sensor probe's vertical axis 3, which corresponds to the surface normal 13 of the surface 11 of the measurement object 12 at the location of the respective sensor probe, relative to a reference axis, i.e., in the case shown here the direction of the earth's gravitational field (F_{g}). The inclinations are indicated with angles α₁, α₂ and α₃. Further, the mechanical links, which are not shown, each have an inclination sensor that detects the inclination of the mechanical links relative to the earth's gravitational field.

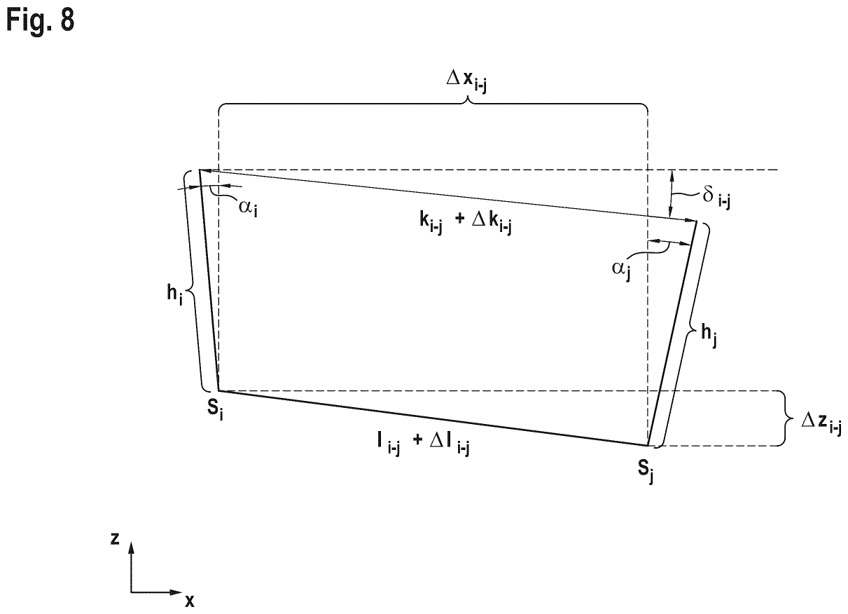

From the measurements of the distances between the sensor probes, i.e. the length of the mechanical links, and the angles α₁, α₂ and as the positions of the sensor probes can be determined from one or more reference points, here the left sensor probe 1. For illustration, FIG. 8 shows the geometric relationships between two neighboring sensor probes (as shown in FIG. 7) with various measured quantities. As above, indices i and j are used for the numbering of the sensor probes. δᵢ₋ⱼ indicates the angle between the longitudinal axis of the mechanical link relative to a plane that is perpendicular to the earth's gravitational field. It can be derived from the measurement of the inclination sensor in the mechanical link. h indicates the distance between the pivot center of the spherical bearing in which the mechanical link is supported on the sensor probe and the surface plane of the measurement object at the location of the respective sensor probe. S indicates the coordinates of the sensor probes in the coordinate system associated with the measurement object. The determined length of the mechanical link kᵢ₋ⱼ+Δkᵢ₋ⱼ does not correspond to the distance lᵢ₋ⱼ+Δlᵢ₋ⱼ on the measurement object surface and therefore must be converted using the angles αᵢ, αⱼ and δᵢ₋ⱼ.

The length lᵢ₋ⱼ+Δlᵢ₋ⱼ can be determined from the angles αᵢ, αⱼ, δᵢ₋ⱼ and the length kᵢ₋ⱼ+Δkᵢ₋ⱼ. The length lᵢ₋ⱼ+Δlᵢ₋ⱼ can be calculated by vector addition. The absolute coordinates X,Z for sensor probe j can be determined as follows:

$${S}_{j , x} = {h}_{i} * sin ( - {α}_{i} ) - {h}_{j} * sin ( {α}_{j} ) + ( {k}_{i - j} + Δ {k}_{i - j} ) * cos ( {δ}_{i - j} ) + {S}_{i , x} \qquad ( 4 )$$

$${S}_{j , z} = {h}_{i} * cos ( {α}_{i} ) - {h}_{j} * cos ( {α}_{j} ) - ( {k}_{i - j} + Δ {k}_{i - j} ) * sin ( {δ}_{i - j} ) + {S}_{i , z} \qquad ( 5 )$$

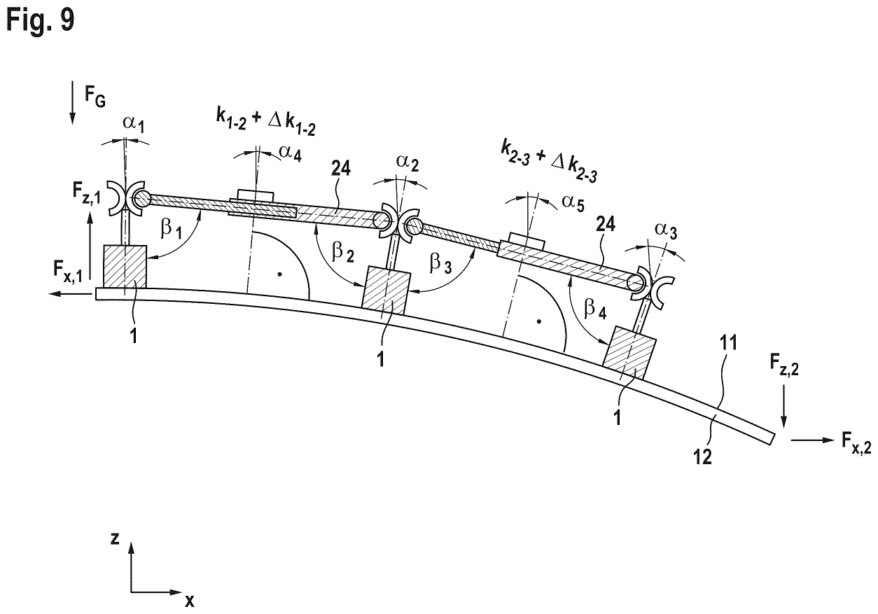

FIG. 9 shows another exemplary embodiment of a measurement system for measuring a bending of a measurement object. The measurement system setup includes an additional angle measurement β between the longitudinal axis of length variable struts 24 (e.g. telescopic rod arrangements) and the vertical axis of sensor probes 1 connected to the respective strut 24. This measurement can be performed at both ends of each strut 24. This setup reduces measurement uncertainties, because multiple information can now be used to calculate the positions of sensor probes. In addition, inclination sensors in the struts can be dispensed with. The relative position of a sensor probe to another probe can be calculated with αᵢ, βᵢ, βⱼ and the length kᵢ₋ⱼ+Δkᵢ₋ⱼ.

The absolute position S₂=(S_{2,x}; S_{2,z}) of the second probe in the X-Z coordinate system of the measurement object 12 can be determined by the coordinate transformation of the concatenation of the individual measured angles α₁,β₁,β₂ with heights h₁, h₂ and the measured distance k₁₋₂+Δk₁₋₂ as follows:

$${R}_{1} = ( \begin{matrix}cos ( - {α}_{1} ) & - sin ( - {α}_{1} ) \\ sin ( - {α}_{1} ) & cos ( - {α}_{1} )\end{matrix} ) \qquad ( 6 )$$

$${R}_{2} = {R}_{1} * ( \begin{matrix}cos ( {β}_{1} - 90 ) & - sin ( {β}_{1} - 90 ) \\ sin ( {β}_{1} - 90 ) & cos ( {β}_{1} - 90 )\end{matrix} ) \qquad ( 7 )$$

$${R}_{3} = {R}_{2} * ( \begin{matrix}cos ( {β}_{2} + 90 ) & - sin ( {β}_{2} + 90 ) \\ sin ( {β}_{2} + 90 ) & cos ( {β}_{2} + 90 )\end{matrix} ) \qquad ( 8 )$$

$$( \begin{matrix}{S}_{2 , x} \\ {S}_{2 , z}\end{matrix} ) = {R}_{1} * ( \begin{matrix}0 \\ {h}_{1}\end{matrix} ) + {R}_{2} * ( \begin{matrix}{k}_{1 - 2} + Δ {k}_{1 - 2} \\ 0\end{matrix} ) + {R}_{3} * ( \begin{matrix}0 \\ {h}_{2}\end{matrix} ) + ( \begin{matrix}{S}_{1 , x} \\ {S}_{1 , z}\end{matrix} ) \qquad ( 9 )$$

R₁ is the rotations matrix to transform the first sensor probe into the global coordinate system. R₂ is used to transform the connecting rod into the global coordinate system. R₃ is the transformation of the second sensor probe into the global coordinate system. R₂ and R₃ are the chaining of the previous rotation matrices.

Angle δ₁₋₂ (shown in FIG. 8) can be derived from rotation matrix in equation 7 with matrix entries of r_{1,2} and r_{2,2}:

$${R}_{2} = ( \begin{matrix}{r}_{1 , 1} & {r}_{2 , 1} \\ {r}_{1 , 2} & {r}_{2 , 2}\end{matrix} ) \qquad ( 10 )$$

$${δ}_{i - j} = arctan ( \frac{{r}_{1 , 2}}{{r}_{2 , 2}} ) \qquad ( 11 )$$

Thus, the absolute position S₂ of the center probe in the coordinate system of the measurement object can also be determined according to equations (4) and (5). From the coordinates of the sensor probes S₁ and S₂, the length l₁₋₂+Δl₁₋₂ can also be determined from

$${l}_{1 - 2} + Δ {l}_{1 - 2} = \sqrt{{( {S}_{1 x} - {S}_{2 x} )}^{2} + {( {S}_{1 , z} - {S}_{2 , z} )}^{2}} \qquad ( 12 )$$

Based on the above relationships, it is possible to identify deformations of the measurement object as a result of tensile, compressive and bending forces. The change in length of the measurement object is determined from the change in length of the mechanical links between the sensor probes. A reference point, whose position is fixed in the coordinate system of the measuring object, can be used to identify the absolute position of the sensor probes in the coordinate system of the measurement object, which means that changes in the shape of the measurement object can be monitored in a precise manner.

In order to obtain additional information about torsion of the measurement object in FIG. 9, the angle θ explained in relation to FIG. 5 and/or information of the triaxial orientation sensor of the sensor probes regarding an inclination around e.g. the X-axis can be evaluated.

As shown in FIG. 2, the distributed sensor probes are placed on the surface of the measurement object according to a 2-dimensional network. A variety of network structures are possible. For example, the sensor probes can be distributed in a matrix configuration, i.e., rectangular arrangement, with up to four connections from one sensor probe to other sensor probes. Due to the two-dimensional distribution of the sensor probes, the positions of the sensor probes relative to one or more reference points in a three-dimensional coordinate system can be effectively determined, e.g., by considering the distances between directly coupled sensor probes, which corresponds to the length of the respective mechanical link, the spatial orientation of each of the sensor probes in space relative to a predetermined reference axis, which defines the orientation of the surface normal of the surface of the measurement object at the location of the respective sensor probe relative to said predetermined reference axis and the spatial orientation of the mechanical links between the sensor probes relative to said surface normal or said reference axis for each of the respective sensor probes.

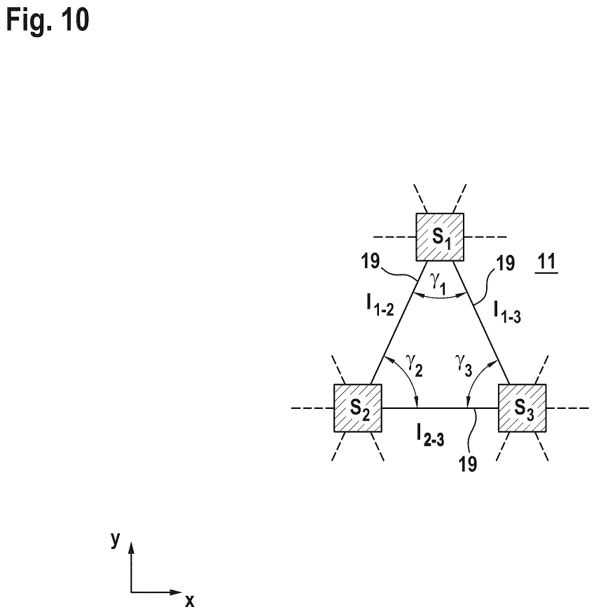

FIG. 10 illustrates the determination of the positions of connected sensor probes on the surface 11 of the measurement object, i.e. in an X-Y coordinate system that is perpendicular to the X-Z coordinate system according to FIG. 9. FIG. 10 shows three sensor probes S₁, S₂ and S₃ of a sensor probe network in a triangular arrangement, which is referred to as standard cell. Sensor probe S₁ is a reference sensor probe and its position in the coordinate system of the measurement object is fixed and known. The sensor probes S₁, S₂ and S₃ form vertices of a triangle. Each of said sensor probes S₁, S₂ and S₃ is directly coupled to the other two sensor probes by a mechanical link 19, respectively. All sensor probes S₁, S₂ and S₃ transmit their measurement signals wirelessly to an analysis unit. The analysis unit is configured to determine the interior angles γ₁, γ₂, γ₃ of the triangle based on the lengths lᵢ₋ⱼ of the mechanical links 19, i.e., the distances between directly coupled sensor probes. The angles γᵢ can be determined from the lengths lᵢ₋ⱼ using the cosine theorem (formula 13). This allows the position of the other two probes S₂ and S₃ to be determined relative to the one reference probe S₁.

$${γ}_{1} = ar cos ( \frac{{l}_{1 - 3}^{2} + {l}_{1 - 2}^{2} - {l}_{2 - 3}^{2}}{2 * {l}_{1 - 3}^{2} * {l}_{1 - 2}^{2}} ) \qquad ( 13 )$$

The sensor probe network allows the dependencies between all measuring probes to be converted into the various deformations as a result of tension, compression, shear and torsion. The deformations can be determined unambiguously on the basis of the network structure. The sensor probe network does not necessarily have to contain a spatially uniform distribution of the sensor probes, e.g., it is possible to use a narrower arrangement of the sensor probes in areas with a high geometrical geometric change or in an area where there is a greater metrological interest.

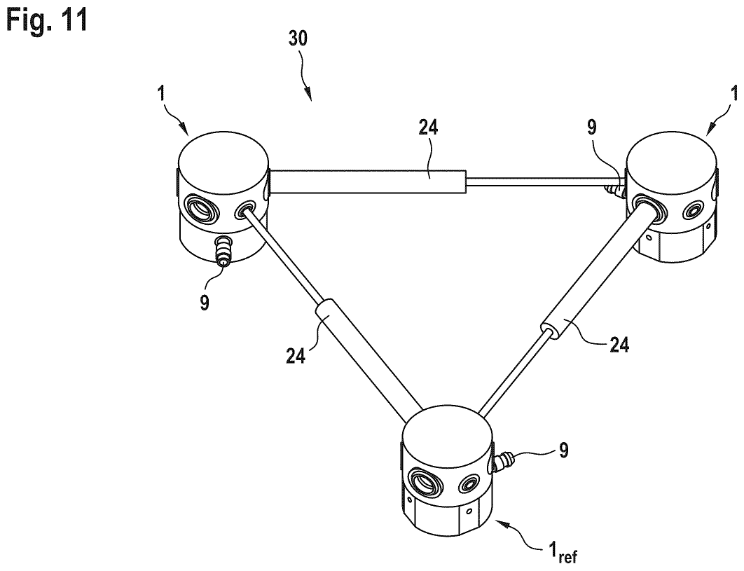

FIG. 11 shows in a perspective view a standard cell 30 as explained with regard to FIG. 10 with three sensor probes 1. The sensor probes are connected by mechanical links in the form of struts 24 with variable length. Each of the sensor probes has a port 9 for connecting the sensor probe to a vacuum source. One of the senor probes can be determined as a reference sensor probe 1_{ref}, its position in a coordinate system of the measurement object is determined. Based on the position of the one reference sensor probe 1_{ref} and the geometric relationships explained above, the positions of the other two sensor probes 1, 1 can be determined.

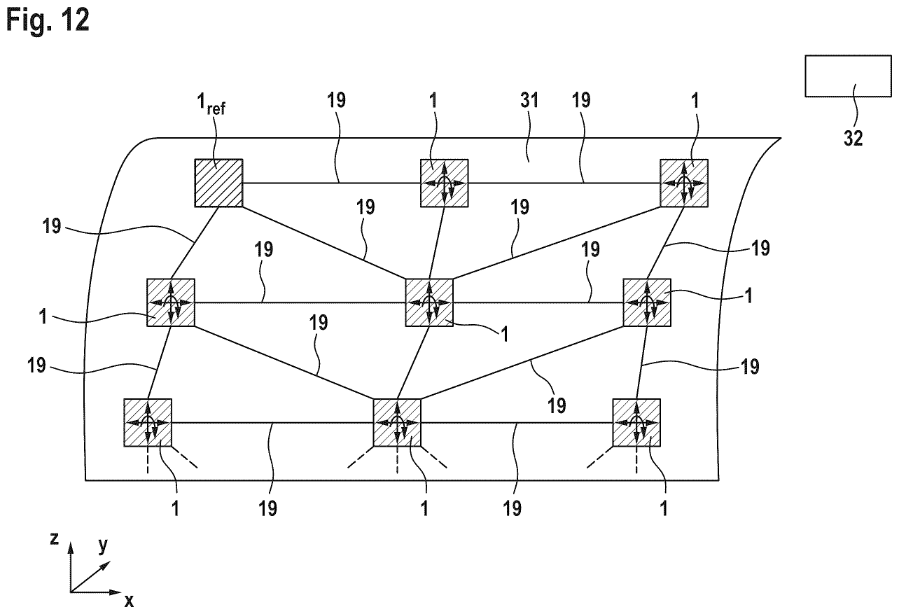

FIG. 12 shows schematically the setup of a measuring system on a measurement object in the form of half shell component 31 in a perspective view.

One of the sensor probes l_{ref} serves as a reference measuring point for the determining the position of the sensor probes 1 in the X-Y-Z coordinate system of the measurement object.

The reference sensor probe is l_{ref} firmly attached to the surface of the half shell component 31 and always has a unique position in the X-Y-Z coordinate system of the measurement object. The other sensor probes 1 can move relative to the reference sensor probe 1_{ref} and have two translational degrees of freedom and one rotational degree of freedom around their own vertical axis, which is indicated by the arrows in the sensor probes 1. This allows the sensor probe network to reflect all deformations of the component 31. The sensor probes can be measured initially, e.g. by photogrammetry and/or laser tracker. This reduces measurement uncertainties, since the positions of all sensor probes are known at the start of the measurement and therefore are not required to be determined from the position of the reference sensor probe.

Each of the sensor probes transmits the measured data wirelessly to an analysis unit 32, for example a unit for electronic data processing.

It is noted that several sensor probe networks or standard cells, as explained above, may distributed over a surface of a measurement object. In this case, the single sensor probe networks may each serve as subnetwork which together form a global sensor probe network, i.e., according to a further embodiment of the invention the sensor probe network is not necessarily contiguous, but several subnetworks or standard cells can be distributed independently over a surface. The single subnetworks may transmit the data of the sensor devices wirelessly to the analysis unit for evaluation.

### REFERENCE NUMERALS

1 sensor probe
1_{ref} reference sensor probe
2 sensor probe body
3 vertical axis of sensor probe
4 lower end of sensor probe
5 upper end of sensor probe
6 open space
7 suction bell
8 channel
9 port for vacuum source
10 mounting surface
11 surface of measurement object
12 measurement object
13 surface normal
14 energy source
15 evaluation circuit
16 triaxial acceleration sensor
17 spherical bearing
18 sensor probe network
19 mechanical link
20 strut with fixed length
21 longitudinal axis
22 inclination sensor
23 wire
24 strut with variable length
25 linear displacement unit
26 distance detection device
27 transmitters
28 lens
29 receiver
30 standard cell
31 half shell component
32 analysis unit

1. A measuring system for determining a shape,
deformations and/or change in orientation of a measurement object, the measuring system comprising:
a plurality of sensor probes attached in a distributed manner on a surface of the measurement object in a predefined orientation relative to a surface normal of the surface of the measurement object at the location of the respective sensor probe, so that a deformation and/or change in orientation of the measurement object causes a change of the position and/or orientation of one or more of the sensor probes;
wherein each of the sensor probes comprises a fastening device for releasably attaching the sensor probe to the surface of the measurement object;
each of the distributed sensor probes is directly coupled to one or more neighboring sensor probes, wherein a plurality of the sensor probes is directly coupled to at least two neighboring sensor probes, thereby forming a two-dimensional sensor probe network, wherein for the direct coupling of two sensor probes, one or more mechanical links are used such that the sensor probes and the mechanical links form the sensor probe network, wherein the sensor probes define nodes of the sensor probe network,
wherein sensor devices are assigned to each of the sensor probes to detect:
the orientation of the surface normal of the surface of the measurement object at the location of the respective sensor probe relative to a predetermined reference axis, and
the orientation of each of the one or more of the mechanical links coupled to the respective sensor probe relative to said surface normal of the surface of the measurement object at the location of the respective sensor probe or said predetermined reference axis, and
wherein an analysis unit is provided which is configured to receive and evaluate measurement signals from the sensor devices, the analysis unit being configured to determine the position and orientation of each of the sensor probes from the received measurement signals.

2. The measuring system according to claim 1, wherein the analysis unit is configured to determine the relative position and/or orientation of each of the sensor probes to directly coupled neighboring sensor probes.

3. The measuring system according to claim 1, wherein the sensor devices comprise sensors to detect the angle between each of the mechanical links coupled to the respective sensor probe and a plane that extends perpendicular to the surface normal of the surface of the measurement object at the location of the respective sensor probe.

4. The measuring system according to claim 1, wherein each sensor device comprises sensors for detecting the orientation of the sensor probe relative to the earth's gravitational field.

5. The measuring system according to claim 1, comprising sensors for detecting the orientations of at least some of the mechanical links relative to the earth's gravitational field by at least one of inclination sensors or triaxial acceleration sensors which are connected to the mechanical links.

6. The measuring system according to claim 1, wherein one or more of the sensor probes are defined as reference sensor probes and the analysis unit is configured to determine the position and orientation of each of the other sensor probes relative to the one or more of the reference sensor probes.

7. The measuring system according to claim 1, wherein:
the mechanical links are variable in length; and
distance detection devices are provided for detecting the distance and/or a change thereof between directly coupled sensor probes.

8. The measuring system according to claim 1, wherein;
the mechanical links are rigid struts or rods; and
the fastening devices of each of the sensor probes allow displacements of the respective sensor probe along the surface of the measurement object within predetermined limits.

9. The measuring system according to claim 1, wherein the sensor probes are directly coupled such that three sensor probes form vertices of a triangle, each of said sensor probes being directly coupled to the other two sensor probes by a mechanical link, respectively, wherein the analysis unit is configured to determine the interior angles (γ₁, γ₂, γ₃) of the triangle based on the length of the mechanical links.

10. The measuring system according to claim 1, wherein the mechanical links are supported on the sensor probes by spherical bearings.

11. The measuring system according to claim 1, wherein:
each of the mechanical links defines a longitudinal axis along which the mechanical link connects two sensor probes; and
the sensor devices comprise sensors to detect a rotation of each of the mechanical links about its own longitudinal axis.

12. The measuring system according to claim 1, comprising transmitters and receivers for electromagnetic, acoustic or optical waves, such as laser beam sources, and receivers for the electromagnetic waves, such as a camera sensor;
wherein the transmitters are attached to the mechanical links and the receivers are attached to the sensor probes, or vice versa, for detecting a rotation of each of the mechanical links about its own longitudinal axis.

13. The measuring system according to claim 1, wherein the sensor probes each include an energy source for self-powered operation.

14. A method of determining a shape, deformations and/or change in orientation of a measurement object, the method comprising the steps of:
providing a measuring system;
distributing and attaching the sensor probes as a network of sensor probes on a surface of the measurement object;
determining the position and orientation of the sensor probes by evaluating the measurement signals provided by the sensor devices;
determining a shape, deformation and/or change in orientation of the measurement object based on the determined positions and orientations of the sensor probes.

15. The method according to claim 14, wherein;
one or more of the sensor probes are defined as reference sensor probes such that absolute coordinates of the reference sensor probes are set with respect to a coordinate system of the measurement object; and
a deformation of the measurement object is determined based on the positions and orientations of the sensor probes relative to the one or more of the reference sensor probes.

16. The method according to claim 14, wherein the determined positions and orientations of the sensor probes are used to control and/or regulate a device for correcting the shape, orientation and/or position of the measurement object by means of actuators.

17. The method according to claim 14, wherein the measurement signals from the sensor devices are wirelessly transmitted to a higher evaluation or processing unit.

18. A measuring system for determining shape, deformations and/or change in orientation of a measurement object, the measuring system comprising:
a plurality of sensor probes attached in a distributed manner on a surface of the measurement object in a predefined orientation relative to a surface normal of the surface of the measurement object at the location of the respective sensor probe, so that a deformation and/or change in orientation of the measurement object causes a change of the position and/or orientation of one or more of the sensor probes;
wherein each of the sensor probes comprises a fastening device for releasably attaching the sensor probe to the surface of the measurement object and the sensor probes each include an energy source for self-powered operation;
each of the distributed sensor probes is directly coupled to one or more neighboring sensor probes, wherein a plurality of the sensor probes are directly coupled to at least two neighboring sensor probes, thereby forming a two-dimensional sensor probe network, wherein for the direct coupling of two sensor probes, one or more mechanical links are used such that the sensor probes and the mechanical links form the sensor probe network, wherein the sensor probes define nodes of the sensor probe network, the mechanical links being supported on the sensor probes by bearings;
wherein sensor devices are assigned to each of the sensor probes to detect:
the orientation of the surface normal of the surface of the measurement object at the location of the respective sensor probe relative to a predetermined reference axis, and
the orientation of each of the one or more of the mechanical links coupled to the respective sensor probe relative to said surface normal of the surface of the measurement object at the location of the respective sensor probe or said predetermined reference axis, and
wherein an analysis unit is provided which is configured to receive and evaluate measurement signals from the sensor devices, the analysis unit being configured to determine the position and orientation of each of the sensor probes from the received measurement signals.

19. The measuring system according to claim 18, comprising sensors for detecting the orientation of at least some of the mechanical links relative to earth's gravitational field by inclination sensors.

20. The measuring system according to claim 18, comprising sensors for detecting the orientation of at least some of the mechanical links relative to earth's gravitational field by triaxial acceleration sensors.
